(19) United States
(12) Patent Application Publication
(10) Pub. No.: US 2024/0185450 A1
(43) Pub. Date: Jun. 6, 2024

(54) Configuring an Immersive Experience

(71) Applicant: KAGENOVA LIMITED, Guildford (GB)

(72) Inventors: Martin ENDER, Guildford (GB); Paulo J.R. DE MELLO, Guildford (GB); Jason MCEWEN, Guildford (GB)

(21) Appl. No.: 18/279,727

(22) PCT Filed: Mar. 1, 2022
(86) PCT No.: PCT/EP2022/055146

§ 371 Date: Sep. 1, 2023

(30) Foreign Application Priority Data
Mar. 1, 2021 (GB) 2102868.3

(51) Int. Cl. G06T 7/73; G06T 19/00

(52) U.S. Cl. CPC G06T 7/73; G06T 19/006

(57) ABSTRACT

An immersive experience is configured. The immersive experience comprises first and second scenes. First and second reference points are identified in the first scene. The first and second reference points are identified in the second scene. A relative bearing between the first and second scenes is determined using the identified first and second reference points in the first and second scenes.

### FIELD The present disclosure relates to configuring an immersive experience.

### BACKGROUND

A virtual tour is a type of immersive experience. Existing virtual tours can allow a user to get an impression of a location of interest, for example from the comfort of their own home. Examples of such locations include, but are not limited to, museums, tourist destinations, and real estate properties.

Existing virtual tours are generally experienced through an internet browser. The user uses a mouse to look around a 360° image and then clicks on other locations to jump to a different viewpoint. Consumer-grade virtual reality (VR) hardware is now widely available. Such hardware can, in principle, provide a user with a much more immersive experience of a virtual tour than is possible using an internet browser. However, many existing tours and tour systems do not provide a sufficiently good immersive experience.

For example, existing tour systems generally lack 6-degrees-of-freedom (6DOF) motion. Virtual tours built from 360° images can sometimes only be viewed with three degrees-of-freedom (3DOF) motion. As such, they are only viewed by the user rotating their head. However, immersive tours with 6DOF motion enable both rotation and translation. This allows the user to move around to explore the space.

In existing tour systems, image configuration within a tour is often defined manually by eyeballing the images and, potentially, a floorplan. This is not generally noticeable in existing systems, since the user experiences these images as discrete and disjoint scenes. Such scenes do not form an accurate physical space.

However, once the user has 6DOF motion and is allowed to explore the tour freely, a lack of accurate correspondence between physical space and the tour can impede the immersive experience. This can be very jarring for the user.

### SUMMARY

According to a first aspect there is provided a method of configuring an immersive experience, the immersive experience comprising first and second scenes, the method comprising:
identifying first and second reference points in the first scene;
identifying the first and second reference points in the second scene; and
determining a relative bearing between the first and second scenes using the identified first and second reference points in the first and second scenes.

According to a second aspect there is provided apparatus configured to perform a method according to the first aspect.

According to a third aspect, there is provided a computer program comprising instructions which, when the program is executed by a computer, cause the computer to perform a method according to the first aspect.

### BRIEF DESCRIPTION OF THE DRAWINGS

For a better understanding of the present disclosure and to show how the same may be carried into effect, there will now be described by way of example only, specific embodiments, methods and processes according to the present disclosure with reference to the accompanying drawings in which:

FIG. 1 shows a block diagram of an example of a system in which immersive experience configuration is carried out in accordance with examples;

FIG. 2 shows a block diagram of an example of a workstation, the example workstation being part of the example system shown in FIG. 1;

FIG. 3 shows a block diagram of an example of a node;

FIG. 4 shows a schematic representation of an example of equatorial alignment;

FIG. 5 shows a schematic representation of image coordinates and spherical coordinates on an equirectangular 360° image;

FIG. 6 shows a correspondence graph of an example collection of nodes;

FIG. 7 shows a schematic representation of an example pair of neighbouring nodes;

FIG. 8 shows a schematic representation of an example of reference points on a unit sphere;

FIG. 9 shows another graph of the example collection of nodes shown in FIG. 6;

FIG. 10 shows another graph of the example collection of nodes shown in FIG. 6;

FIG. 11 shows another graph of the example collection of nodes shown in FIG. 6;

FIG. 12 shows another graph of the example collection of nodes shown in FIG. 6;

FIG. 13 shows a schematic representation of an example of triplet correspondence;

FIG. 14 shows a schematic representation of an example of edge length determination;

FIG. 15 shows another graph of the example collection of nodes shown in FIG. 6; and

FIG. 16 shows another graph of the example collection of nodes shown in FIG. 6.

### DETAILED DESCRIPTION

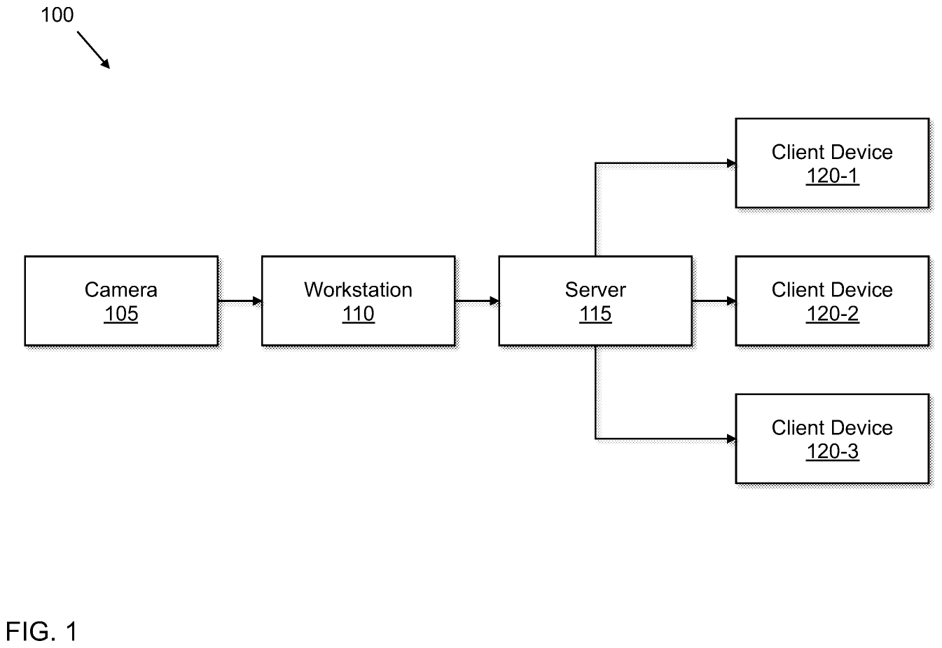

Referring to FIG. 1, there is shown an example of a system 100. Techniques described herein for configuring an immersive experience may be implemented in such an example system 100. Such a system 100 may facilitate automatic and accurate tour alignment, as described in more detail herein.

In this specific example, the system 100 comprises a camera 105, a workstation 110, a server 115 and three client devices 120-1, 120-2, 120-3. The system 100 may comprise different elements in other examples. In particular, the system 100 may comprise a different number of client devices 120 in other examples. The client devices 120-1, 120-2, 120-3 may take various forms. Examples include, but are not limited to, a browser running on a computing device, such as a personal computer (PC) or mobile device, a standalone VR headset, and a tethered VR headset together with a computing device.

The camera 105 is a type of scene-capture device. A scene-capture device may also be referred to as a scene-acquisition device. The camera 105 captures (also referred to herein as “acquires”) scenes. In relation to scene acquisition, an image-based virtual tour, in accordance with examples described herein, may be captured (also referred to herein as “shot”) in various different ways.

For example, the camera 105 may comprise a dedicated 360° camera.

Alternatively, or additionally, the camera 105 may comprise a ‘regular’ camera; in other words, a camera that is not a dedicated 360° camera. Several photographs may be taken from the same location as each other to cover an entire image sphere. This may use functionality found on most current smartphones. The photographs can be stitched into a 360° image in post-production. The location at which a scene is captured may be referred to herein as a “capture viewpoint” or a “camera viewpoint”.

Unlike existing systems, examples described herein support video-based virtual tours. In examples, video-based virtual tours use separate 360° cameras. The 360° cameras record a scene from different viewpoints at the same time. For example, such 360° cameras may have back-to-back fisheye lenses. Inpainting algorithms may be used to remove each camera 105 and tripod from the recordings.

Some existing tour systems require specialised stereo or depth cameras. However, at least some examples described herein are compatible with standard 360° scenes from any camera 105 that can capture them.

As will be described in more detail, the example system 100 enables images, which make up 360° scenes, to be positioned and aligned accurately within the physical space of a tour. As explained above, it can be very jarring, in existing systems, to a user to walk from one viewpoint to another and have the environment suddenly rotate by a few degrees, or for the user to experience a mismatch between the distances moved in the user's play area and in the virtual environment. The example system 100 provides more accurate positioning and rotation (also referred to herein as “orientation”) of each 360° scene making up a tour, to provide an improved immersive experience.

The present disclosure makes virtual tours more natural for VR or browser-based experiences. The user can move anywhere so they can freely explore the tour space. The present disclosure also generalises virtual tours to support not only static images, but 360° video content as well. This enables more types of immersive storytelling and experience.

The present disclosure also provides numerous techniques and authoring tools that facilitate accurate and automated tour alignment, making configuring a virtual tour more accurate and convenient.

Data used in examples described herein to define a virtual tour, its acquisition process, and related technologies will now be described.

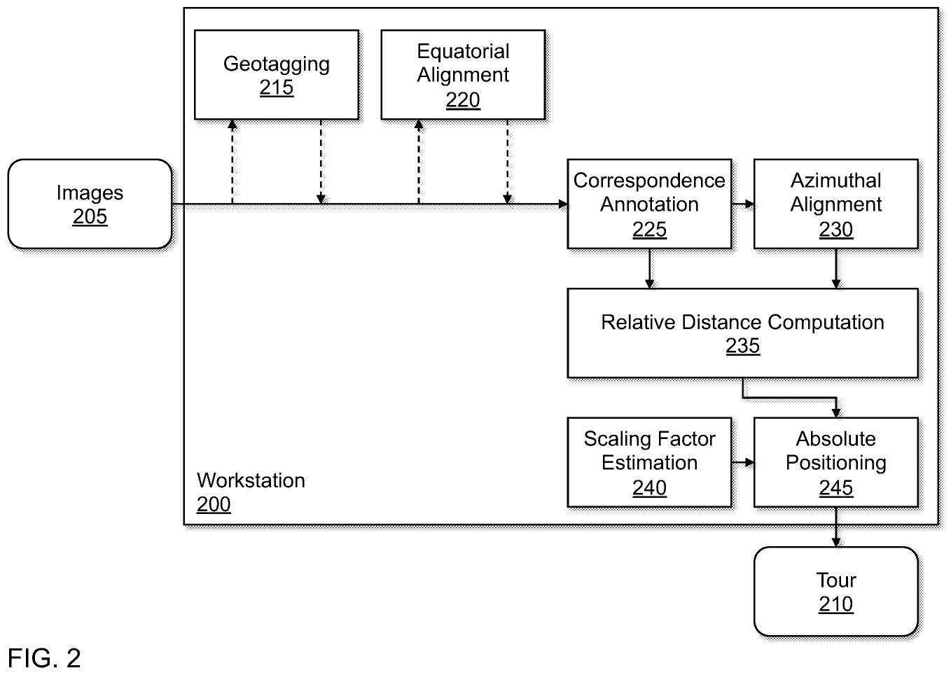

Referring to FIG. 2, there is shown an example of a workstation 200. The workstation may correspond to the workstation 110.

Although various components of the example workstation 200 are depicted in FIG. 2, such components are intended to represent logical components of the example workstation 200. Functionality of the components may be combined and/or divided. In other examples, the workstation 200 comprises different components from those shown, by way of example only, in FIG. 2.

In this example, the workstation 200 receives images 205. The workstation 200 may receive the images 205 from the camera 105. In this example, the images 205 make up multiple 360° scenes.

In this example, the workstation 200 outputs a tour 210. Such a tour 210 may be referred to herein as a “fully configured” tour 210. The term “tour” is used herein to mean a collection of panoramic images and/or videos with a specific spatial relationship. As will be described in more detail below, a tour comprises a number, n, of nodes, N₁ to Nₙ. The term “panoramic” is used herein usually, but not exclusively, to refer to 360° content. However, panoramic 180° and 120° images exist and may be used in accordance with techniques described herein.

In this example, the workstation 200 comprises a geotagging component 215. The geotagging component 215 enables geotagging data to be used to obtain an initial tour configuration for the fully configured tour 210.

In this example, the workstation 200 comprises an equatorial alignment component 220. The equatorial alignment component 220 undoes any camera tilt in the individual 360° scenes. A geometric technique for equatorial alignment based on parallel lines and a computer vision/machine learning technique for equatorial alignment are described in more detail below.

In this example, the workstation 200 comprises a correspondence annotation component 225. The correspondence annotation component 225 enables image correspondences to be identified. Image correspondences, and several techniques that may be used to obtain them, are described below.

In this example, the workstation 200 comprises an azimuthal alignment component 230. The azimuthal alignment component 230 determines an orientation for each scene so that all scenes in the tour are aligned consistently. The azimuthal alignment component 230 also determines a direction of travel between pairs of nodes and, hence, relative bearings between nodes. A geometric technique for azimuthal alignment based on image correspondences and great circles is described below.

In this example, the workstation 200 comprises a relative distance computation component 235. The relative distance computation component 235 computes the relative distances between triplets of nodes.

In this example, the workstation 200 comprises a scaling factor estimation component 240. The scaling factor estimation component 240 estimates an overall scaling factor of the tour. Various techniques for estimating the scaling factor are described below, including a technique based on image correspondences and a technique based on machine learning. In some examples, the scaling factor estimation component 240 uses the received images 205 to estimate the overall scaling factor. In other examples, the scaling factor estimation component 240 estimates the overall scaling factor in another manner, for example based on user measurement.

In this example, the workstation 200 comprises an absolute positioning component 245. The absolute positioning component 245 determines a final configuration of the tour 210.

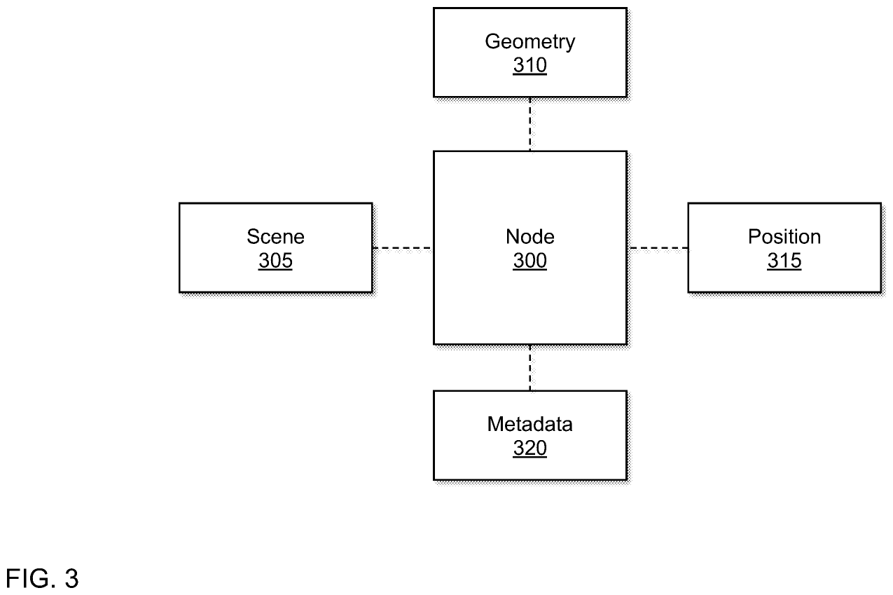

Referring to FIG. 3, there is shown an example of a node 300. As explained above, a tour comprises n nodes, N₁ to Nₙ. Various entities related to the node 300 are shown in FIG. 3. Such entities may be considered to be comprised in the node 300, associated with the node 300, or otherwise related to the node 300.

In this example, the node 300 comprises a scene 305, a geometry 310, a position 315 and metadata 320. The node 300 may comprise different entities in other examples.

In a specific example, the ith node, Nᵢ, of the tour is associated with a 360° scene 305, a node geometry 310, a two-dimensional (2D) position 315, rᵢ=(xᵢ, yᵢ), and an orientation 320, ψᵢ. The 360° image(s) or video(s) with which a node is associated are referred to herein as the “scene” of that node. The orientation, ψᵢ, indicates the counterclockwise rotation of the 360° image or video from the positive y-axis. The scene 305 may comprise panoramic image data and/or panoramic video data.

As explained above, in existing systems, nodes of a tour are positioned by hand to match, roughly, the physical space the tour represents. This may be sufficient for existing tour systems, where the user merely ‘teleports’ from viewpoint to viewpoint and the nodes are largely disconnected experiences. However, for more immersive experiences, for example tours, as described herein, the positions and orientations of nodes should closely match the physical environment to provide a more realistic experience. Once the user can physically walk from node to node, enabling individual objects to stay in the same location gives them a permanence that greatly enhances the user's immersion.

The present disclosure facilitates automated tour setup by providing a system 100 that aids a tour author in orienting and placing the nodes of the tour accurately and with relatively little effort. This system 100 can be used to partially or fully automate the process of building a tour from 360° scenes. Any amount of automation of this process can enhance tour systems. While existing systems do not rely on high accuracy, the fully or partially automated techniques described herein can still reduce the amount of work on the part of a tour author in configuring such tours.

The present disclosure provides, and encompasses, both 2D and 3D techniques. More specifically, techniques described herein for orienting and positioning nodes of a tour can be applied in two or three dimensions. In 2D, each scene's rotation about the north pole and each node's position in the horizontal plane is determined. In 3D, each scene can be freely rotated, and each node can be positioned in 3D space. An example rotation is described below. The 2D technique assumes that each scene is upright; in other words, it assumes that there is no camera tilt. A pre-processing technique, equatorial alignment, is described below to correct any camera tilt. The 3D technique may not include such pre-processing because camera tilt is corrected as part of fixing each node's 3D orientation. The present disclosure relates primarily to the 2D technique. However, it is emphasised again that the techniques described herein may be extended to the 3D technique.

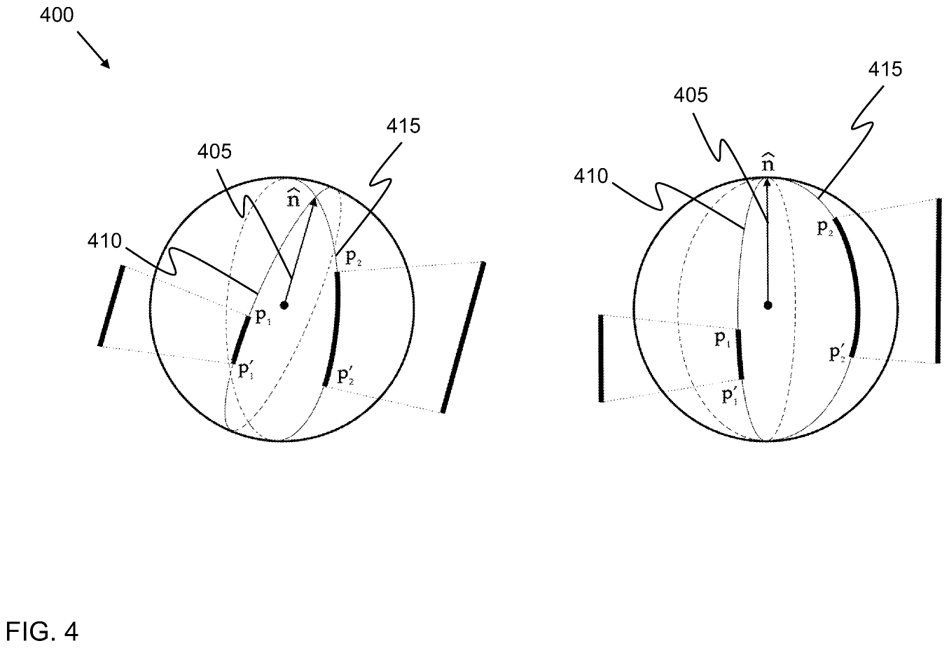

Referring to FIG. 4, there is shown schematically an example of a technique 400 for performing equatorial alignment. Equatorial alignment may be performed by the equatorial alignment component 220 described above.

When capturing 360° scenes, the camera 105 may not be entirely level. This tilts the entire captured scene. This, firstly, reduces the user's immersion if the tilt is strong enough to be noticeable. It might even induce motion sickness if the user feels like the entire world is tilted around them. Secondly, tilted scenes can result in incorrect results from subsequent automated positioning and alignment of tour nodes, such as the techniques described herein.

In this example, each scene in the tour is rotated to undo any tilt. This technique is referred to herein as “equatorial alignment” as it aligns the scene's equator with the physical space's horizontal plane. There are several different ways in which equatorial alignment may be performed.

A first example technique 400 for equatorial alignment, shown in FIG. 4, uses parallel lines to perform equatorial alignment. This example uses parallel lines from the tour's physical environment as a reference. The parallel lines may be vertical lines. Examples of vertical lines include, but are not limited to, door frames, the corners of a room and lamp posts. When projected onto a sphere, vertical lines run along great circles which connect the north and south poles, as shown in FIG. 4. As such, if a scene has two vertical lines, the great circles they lie on can be computed, and the intersection of those lines can be used to find the physical north pole. Although this example relates to parallel lines that are vertical, this technique works similarly for other parallel lines. In particular, this technique can be applied to parallel lines which are not vertical.

Two intersecting great circles have two antipodal intersections. This example assumes that the camera is tilted by less than 90°. The intersection in the southern hemisphere is discarded. To increase the robustness of the alignment, more than two vertical lines can be used. In examples, the north pole is computed for each pair of parallel lines and an average of the vectors obtained is taken. Another function of the vectors, other than an average, may be used in other examples. In the example shown in FIG. 4, the north pole, \hat{n}, 405 of a scene with camera tilt is found by the intersection of two great circles 410, 415.

Once the physical north pole, \hat{n}, has been determined, its spherical coordinates, (ϕ, θ, r) , may be obtained through a coordinate transform. Converting a vector x=(x, y,z)^{T} with magnitude r=\sqrt{x²+y²+z²} to spherical coordinates may be defined as:

θ=tan⁻¹(\sqrt{x²+y²}/z)=Θ(x); and

ϕ=tan⁻¹(y/x)=Φ(x).

Converting spherical coordinates to Cartesian coordinates may be given by:

x=r cos ϕ sin θ=Xₓ(r,θ,ϕ);

y=r sin ϕ sin θ=X_{y}(r,θ,ϕ); and

z=r cos θ=X_{z}(r,θ,ϕ).

This may, alternatively, be represented as:

x=X(r,θ,ϕ)=(Xₓ(r,θ,ϕ),X_{y}(r,θ,ϕ),X_{z}(r,θ,ϕ))^{T}.

For shorthand, the following function may be defined when a point is on the unit sphere:

\hat{x}=X(θ,ϕ)=(Xₓ(1,θ,ϕ),X_{y}(1,θ,ϕ),X_{z}(1,θ,ϕ))^{T}.

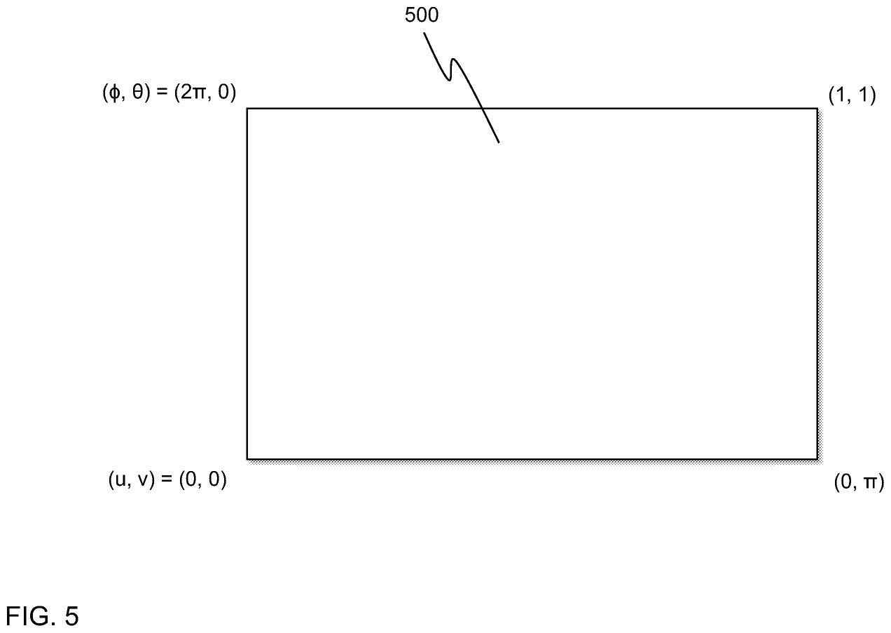

FIG. 5 represents image coordinates and spherical coordinates on an equirectangular 360° image 500. 360° images may be represented as rectangular images, whose horizontal and vertical axes, u and v, are mapped linearly to the spherical coordinates ϕ and θ, respectively. However, the scaling and origin of the image coordinates differs from spherical coordinates. The following conversions may be used:

$$ϕ = 2 π ( 1 - u ) ; \\ θ = π ( 1 - v ) ; \\ u = 1 - \frac{ϕ}{2 π} ; and \\ v = 1 - \frac{θ}{2} .$$

Referring again to FIG. 4, the scene that has been subject to camera tilt (shown on the left in FIG. 4 and depicting vertical lines in the reference frame of the tilted camera) is rotated by the 3D rotation R_{(0,-θ,-ϕ)}to align the physical north pole with the scene's north pole. This is shown on the right in FIG. 4, depicting vertical lines after equatorial alignment. In terms of rotation matrices, examples adopt the zyz Euler convention corresponding to rotation of a physical body in a fixed coordinate system about the z, y and z axes by γ, β and α respectively. The rotation matrix representing such a rotation may be defined by:

R [symbol] =R_{(α,β,65 )}=R_{z}(α)R_{y}(β)R_{z}(γ).

The 3D rotation matrices for the rotation about each axis are given by:

$${R}_{x} ( θ ) = [ \begin{matrix}1 & 0 & 0 \\ 0 & cos θ & - sin θ \\ 0 & sin θ & cos θ\end{matrix} ] ; \\ {R}_{y} ( θ ) = [ \begin{matrix}cos θ & 0 & sin θ \\ 0 & 1 & 0 \\ - sin θ & 0 & cos θ\end{matrix} ] ; and \\ {R}_{z} ( θ ) = [ \begin{matrix}cos θ & - sin θ & 0 \\ sin θ & cos θ & 0 \\ 0 & 0 & 1\end{matrix} ] .$$

In this example, rotations about the x axis are not considered. However, the x axis rotation matrix is nevertheless included for completeness.

The inverse rotation may be defined as:

R⁻¹( [symbol] )=R⁻¹(α,β,γ)=R(−γ,−β,−α)=R_{z}(−γ)R_{y}(−β)R_{z}(−α).

There are several ways in which this rotation can be applied. For example, the actual scene file 305 can be rotated, the existing scene can be resampled and, possibly, interpolated, and the correctly aligned scene may be used subsequently. Alternatively, the angular representation of the north pole may be stored as metadata 320, which can then be accounted for subsequently. In this example, the scene is rotated up-front.

As such, parallel lines, when projected onto a sphere, define great circles. A vector from the origin to the intersection of these great circles is always parallel to the two initial lines. FIG. 4 exemplifies this for vertical lines, whose intersections lie at the north and south poles. If the vector obtained differs from the known direction of these lines in physical space, the discrepancy is due to the camera being tilted. A rotation can then be applied to the image which transforms the lines so that they match their known direction.

There are several ways in which parallel lines can be obtained from 360° scenes. In some examples, a user interface (UI) allows the tour author to annotate a 360° scene with great circles and/or parallel lines. The tour author can use this to define great circles for several parallel lines. Alternatively or additionally, machine learning and/or computer vision algorithms can be used to detect parallel lines in 360° images, which can then be used as input to the equatorial alignment.

A second example technique for equatorial alignment uses machine learning. Instead of, or as well as, using machine learning to provide input to the parallel-lines-based equatorial alignment technique described above, machine learning algorithms can be trained to determine the physical north pole in a 360° scene directly. For example, a regression model can be trained on the rotation that would need to be applied to align the true and captured north poles. This can be achieved by training a model using 360° images where known rotations have already been applied. For example, the above-described rotation may be applied to perform a rotation that simulates a camera tilt, instead of using data that has already been rotated owing to camera tilt. The model then learns to estimate that rotation.

To rotate video content, each frame of the video is rotated. If the camera 105 that captured the video is perfectly still throughout the video, only a single overall tilt for the video may be determined. The same rotation may be applied to each frame. Otherwise, the tilt for each frame can be determined individually. Camera jitter can thereby be corrected.

As such, equatorial alignment of the first and/or second scenes may be performed such that equators of first and/or second scenes are both horizontal. The equatorial alignment may include, for the first and/or second scene, (i) identifying parallel lines in the scene and (ii) rotating the scene such that a direction of the identified parallel lines corresponds to a direction of the corresponding reference parallel lines in physical space. The equatorial alignment may alternatively or additionally involve using machine learning and/or computer vision.

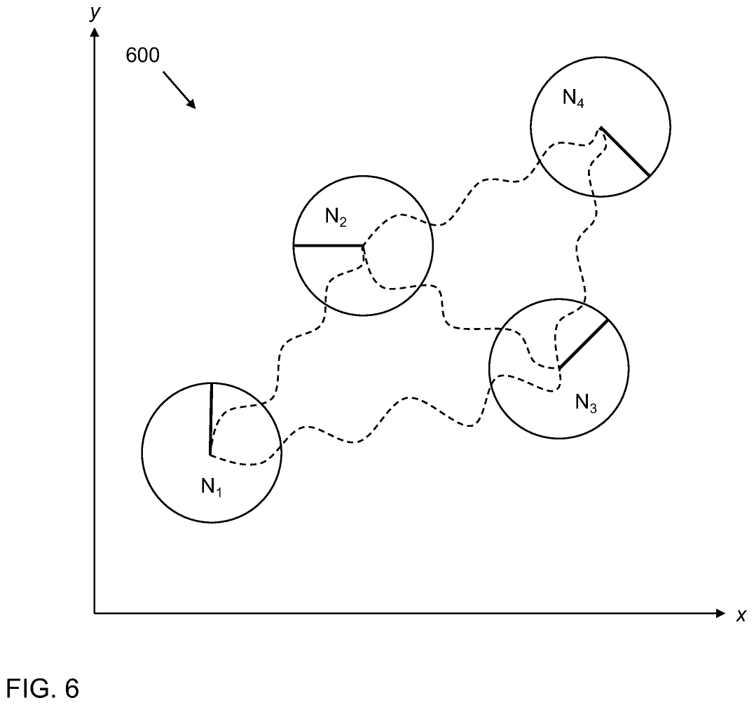

Referring to FIG. 6, there is shown a graph 600 of a collection of four nodes, N₁ to N₄, on an x-y plane. The nodes, N₁ to N₄, have not yet been aligned. Their relative and absolute positions have not yet been determined. The wavey, broken lines between the nodes indicate that the angles (relative bearings) and lengths between the nodes is currently unknown. The graph 600 represents a correspondence graph, in which orientations, bearings, distances and positions are unknown.

With all scenes of the tour equatorially aligned following equatorial alignment by the equatorial alignment component 220, the entire tour can be set up. This involves recovering where each node's scene was shot in physical space, and how the camera 105 was oriented. Since the present disclosure allows the user to physically walk through the virtual tour, the scenes should represent the physical space as accurately as possible.

Alignment can be broken down into two steps.

First, each node's orientation is recovered, and a network of relative bearings is built up. The relative bearings indicate in which direction each node lies relative to other nearby nodes. Second, the relative distances between the nodes are determined to enable their exact positions to be recovered.

The first step is referred to as “azimuthal alignment”, as it is concerned with the recovery of azimuthal angles. Azimuthal alignment may be performed by the azimuthal alignment component 230 described above. Azimuthal angles are angles in the horizontal (x-y) plane. There are two azimuthal angles involved. The first azimuthal angle is the orientation of each node. The orientation of a node is the rotation of a node about its own north pole. The second azimuthal angle is the relative bearing of a node with respect to another node. The relative bearing is the angle of the line connecting one node to another.

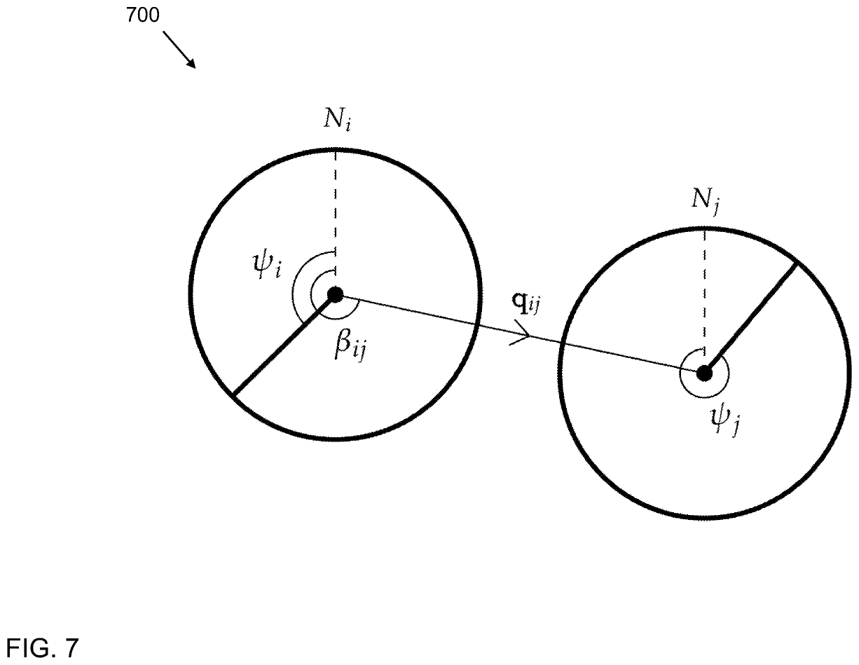

Referring to FIG. 7, there is shown a representation 700 of the orientations, ψᵢ and ψⱼ, of two nodes, Nᵢ and Nⱼ, (with respect to their own north poles) as well as the direction of travel, qᵢⱼ and bearing, βᵢⱼ, between them. As such, FIG. 7 shows the azimuthal angles, namely the orientations and a bearing, that are determined for this pair of nodes, Nᵢ and Nⱼ. The techniques for recovering these angles are interlinked and will now be described in conjunction with each other.

To begin with, it is assumed that both of a pair of nodes, Nᵢ and Nⱼ, are already oriented (in other words, orientations ψᵢ and ψⱼ have already been set), and that only the relative bearing, βᵢⱼ, between them is to be found.

The bearing, βᵢⱼ, is the azimuthal angle, ϕ, of the direction of travel, qᵢⱼ, from Nᵢ to Nⱼ. Use is made once again of great circles.

In more detail, a great circle is the intersection between a sphere and a plane that passes through the sphere's centre. They are largest circles that can be drawn on a sphere. In terms of representing great circles, the present example uses unit spheres at the origin of an appropriate coordinate system. Great circles can be represented by their normal vector. The normal vector is the normal of the plane that intersects the sphere to form the great circle.

To find the great circle connecting two points, let p₁ and p₂ be two points on the unit sphere. The great circle containing both these points is the intersection of the sphere with the plane passing through the two points and the origin. The plane is uniquely described by its unit normal û= [symbol] .

Two great circles always intersect in two antipodal points, q₁ and q₂. If the great circles are described by normals û and \hat{v}, their intersections lie at:

q₁=û×\hat{v}; and

q₁=−û×\hat{v}.

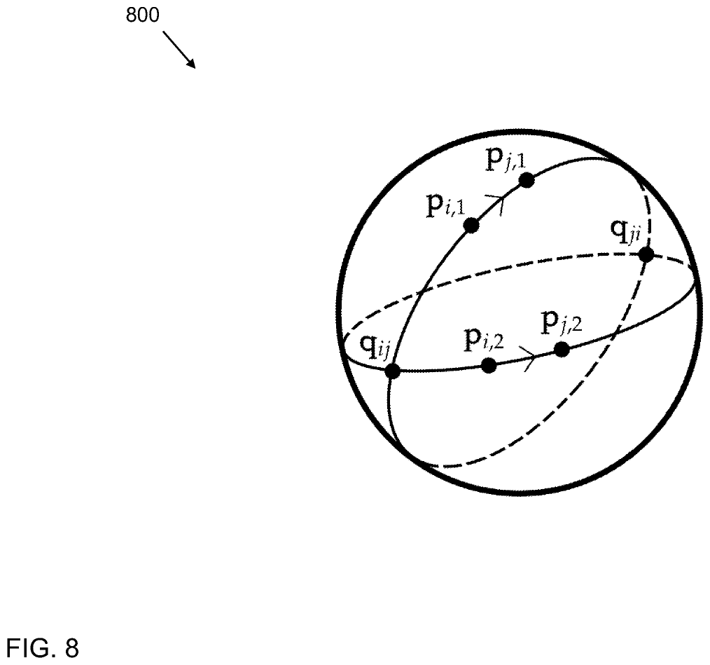

With reference to FIG. 8, there is shown a representation 800 of two small points of interest, which can be seen from two nodes, Nᵢ and Nⱼ. A point of interest may be referred to herein as a “reference point”. Examples of reference points include, but are not limited to, the corner of a table, the base of a road sign and the tip of a distinctive tree branch. Each reference point appears at a point, pᵢ, in the first scene and at a point, pⱼ, in the second scene. Such a pair of reference points may be referred to herein as a “correspondence”. If the correspondence is treated as points on the same unit sphere, such as is shown in FIG. 8, they are connected by a great circle which also passes through the direction of travel, q ᵢⱼ, from Nᵢ to Nⱼ. Hence, if there are two independent correspondences (in other words, two independent pairs of reference points) in the same pair of scenes, the intersections of those great circles can be found to determine the direction of travel.

Again, there will be two antipodal intersections. One is the true direction of travel, qᵢⱼ, and the other is the opposite direction, qⱼᵢ=−qᵢⱼ. To identify which of the two points the camera 105 has travelled towards, the observation that the direction of a fixed point of interest becomes increasingly dissimilar to the direction of travel is used. Therefore, the intersection point, q, corresponding to the true direction of travel satisfies pᵢ·q>pⱼ·q. The azimuthal angle, ϕ, of the direction of travel, qᵢⱼ, is the bearing, βᵢⱼ, of interest.

In practice, however, the orientation of the second node, Nⱼ, is not yet known. This means that the second point, pⱼ, could be rotated about the north pole of its own image (not the north pole of the unit sphere described above) by an arbitrary angle, ψⱼ. However, all such points, p_{j,m}, from various correspondences, where m is the correspondence index, would be rotated by the same arbitrary angle, ψⱼ. This allows the orientation to be recovered by using additional correspondences as follows.

Suppose there are n correspondences (pairs of points of interest) between the two nodes, each of which defines a great circle. The above computation can be used to obtain a direction of travel for each pair of great circles. Only if the second node is oriented correctly, will all of these intersections align. A numerical solver can be used to find the solution to:

ψⱼ=argmin[∈(ψⱼ)];

∈=Σ_{ab}∈_{ab}; and

∈_{ab}=∥qₐ−q_{b}∥₂²,

where qₐ is the ath intersection found in the great circles. The above three equations, in effect, find the value of the orientation, ψⱼ, that minimises the differences in the intersections found in the great circles.

As such, in this example, the relative bearing, βᵢⱼ, is determined by determining a first direction of travel, qᵢⱼ, between the first and second scenes using a difference between positions of a first reference point, p_{i,1} and p_{j,1}, in the first and second scenes and a difference between positions of a second reference point, p_{i,2} and p_{j,2}, in the first and second scenes. In this example, these differences in positions are used to identify great circles, and intersection points of the great circles. The intersection points are used to determine the first direction of travel, qᵢⱼ. The relative bearing, βᵢⱼ, is derived using (at least) the first determined direction of travel, qᵢⱼ.

Typically, using four correspondences yields the correct orientation 90% of the time, in the presence of ˜1° of noise. To improve the accuracy of this technique further, seven correspondences may be used, the above technique may be run on every subset of five correspondences of the seven correspondences, and the median result may be taken. Additional correspondences may be used to increase the robustness further. Other techniques may be used to improve the accuracy further.

As such, the first and second scenes may each include a third reference point, p_{i,3} and p_{j,3} (not shown in in FIG. 8). The third reference point gives a third correspondence and, hence, a further great circle, further intersection points, and further directions of travel. Determining the relative bearing, βᵢⱼ, may comprise determining at least one further direction of travel between the first and second scenes. The at least one further direction of travel between the first and second scenes may be determined using the difference between positions of the first reference point, p_{i,1} and p_{j,1}, in the first and second scenes and the difference between positions of the third reference point, p_{i,3} and p_{j,3}, in the first and second scenes. The at least one further direction of travel between the first and second scenes may, additionally or alternatively, be determined using the difference between positions of the second reference point p_{i,2} and p_{j,2} in the first and second scenes and the difference between positions of the third reference point p_{i,3} and p_{j,3} in the first and second scenes. The relative bearing, βᵢⱼ, may be derived using the at least one further determined direction of travel, in addition to the first determined direction of travel, qᵢⱼ.

The at least one further direction of travel may include two or more further directions of travel. In particular, a first further direction of travel between the first and second scenes may be determined using the difference between positions of the first reference point p_{i,1} and p_{j,1}, in the first and second scenes and the difference between positions of the third reference point p_{i,3} and p_{j,3}, in the first and second scenes. A second further direction of travel between the first and second scenes may be determined using the difference between positions of the second reference point p_{i,2} and p_{j,2}in the first and second scenes and the difference between positions of the third reference point p_{i,3} and p_{j,3} in the first and second scenes.

The first determined direction of travel, qᵢⱼ, may be different from the at least one further determined direction of travel. In such cases, the difference between the first determined direction of travel, qᵢⱼ, and the at least one further determined direction of travel is dependent on an orientation of the first and/or second scene, ψᵢ and ψⱼ. Azimuthal alignment of the first and second scenes may be performed. Such azimuthal alignment may comprise orienting the first and/or second scene to minimise the difference between the first determined direction of travel, qᵢⱼ, and the at least one further determined direction of travel. The difference between the first determined direction of travel, qᵢⱼ, and the at least one further determined direction of travel may be reduced to zero in some cases, or may be non-zero in other cases.

An immersive experience, such as a tour, is therefore configured. The tour comprises first and second scenes associated with first and second nodes, Nᵢ and Nⱼ, respectively. First and second reference points, p_{i,1} and p_{i,2}, are identified in the first scene. The same first and second reference points, p_{j,1} and p_{j,2}, are identified in the second scene. A relative bearing, βᵢⱼ, between the first and second scenes is identified using the identified first and second reference points in the first and second scenes, p_{i,1}, p_{i,2}, p_{j,1} and p_{j,2}.

As such, FIG. 8 represents how the direction of travel, qᵢⱼ, from node Nᵢ to node Nⱼ can be determined based on correspondences, p_{i,1} and p_{j,1}, and p_{i,2} and p^{j,2}. Great circles passing through each correspondence intersect in the direction of travel, qᵢⱼ.

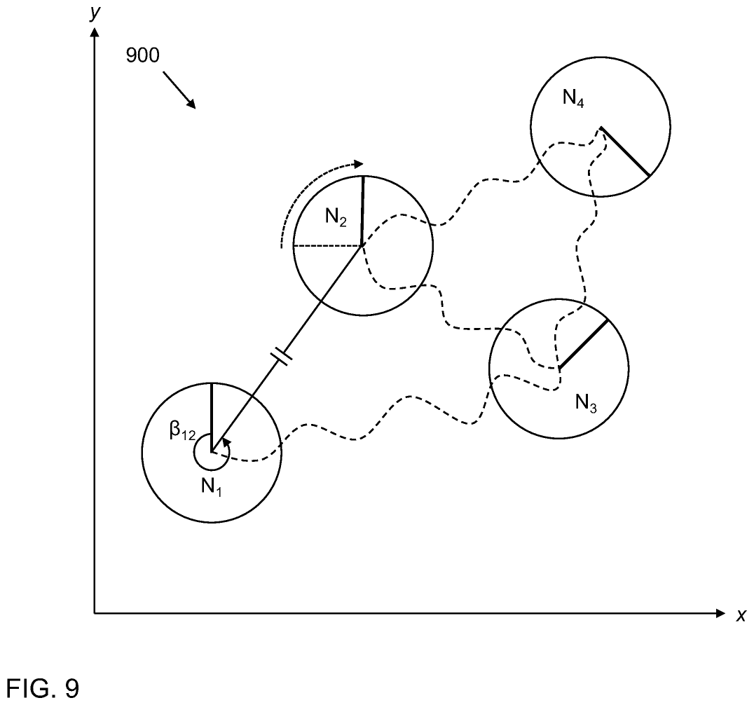

Referring to FIG. 9, there is shown a graph 900 in which the orientations of the first and second nodes, N₁ and N₂, have been aligned and in which the relative bearing, β₁₂, between them has been fixed. The distance between the first and second nodes, N₁ and N₂, is not yet known, as indicated by the straight line with a break between them.

Orientations and a bearing graph for the entire tour are then computed. In particular, the above techniques may be applied repeatedly to find the orientations of all nodes in the tour and to compute a graph of bearings. The graph of bearings is used to fix the relative positions of the nodes.

A correspondence graph of the tour may be defined as follows. The graph's nodes are the nodes of the tour. There is an undirected edge between each pair of nodes for which there is a sufficiently large set of correspondences. The graph should be a connected graph.

An arbitrary node is taken and is assigned an arbitrary orientation. For ease of use, the scene in which the user starts the tour may be used. This also allows direct control of the way in which the user will be facing by default. Each edge of the graph is processed in breadth-first order, starting at this initial node, and applying the above technique to each edge. Owing to this traversal order, by the time an edge has been processed, one of its nodes will already have its orientation determined. Hence, the algorithm from the previous section can be used to fix the other node's orientation and assign a bearing to the edge.

If the correspondence graph has the smallest possible number of edges (in other words, if it is a minimum spanning tree of the tour), there is exactly one orientation per node, so there is no ambiguity. However, there is a risk of compounding errors, since each orientation can only be computed relative to the last. This computation can be made more robust by adding correspondences for redundant edges, so there are loops in the graph. Each loop means that there are two paths to reach any node on that loop.

There are various ways in which this redundancy can be used to reduce errors. When multiple orientations for a node disagree, one or more of the following measures can be used to minimise the overall errors of the azimuthal alignment step. Firstly, the results can be averaged. Secondly, the discrepancy can be evenly spread out among all orientations along the loop. Thirdly, an uncertainty measure can be obtained for each orientation, for example a minimal disagreement, d, and the correction can be weighted for each orientation along the loop by the associated uncertainty. Fourthly, a relaxation algorithm can be applied to the whole graph.

Redundancy in the correspondence graph also helps make the final step of fixing the edge lengths more robust.

Obtaining accurate correspondences between scenes improves azimuthal alignment results. As with equatorial alignment, there are two primary ways to acquire the correspondences. Such correspondences can be obtained by the correspondence annotation component 225 described above. A UI can let the author of the tour quickly and accurately annotate scenes with correspondences. As such, the first and second reference points may be identified in the first and second scenes based on user input indicating the first and second reference points. Alternatively or additionally, machine learning or computer vision methods can be used to find correspondences between scenes automatically. This significantly reduces the manual effort required to author a tour. As such, the first and second reference points may be identified in the first and second scenes based on machine learning and/or computer vision.

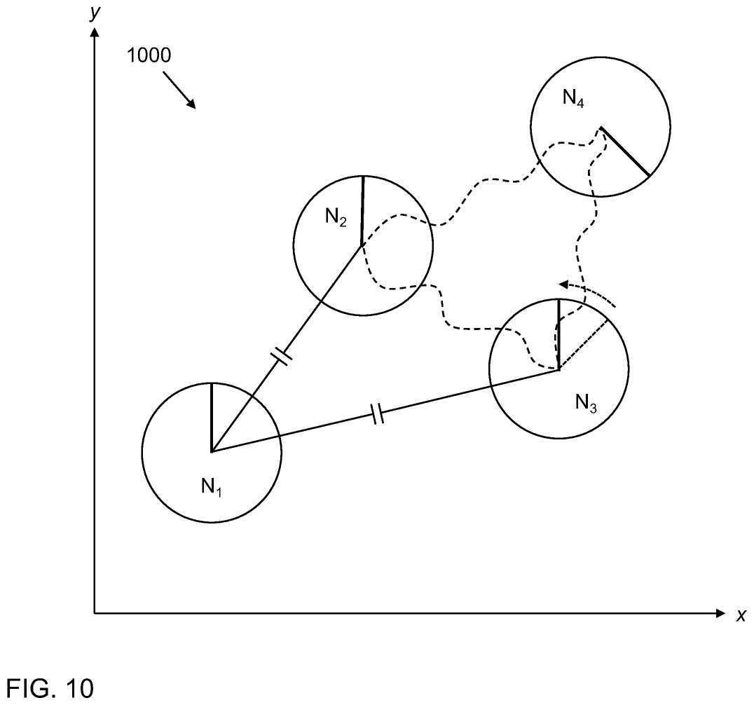

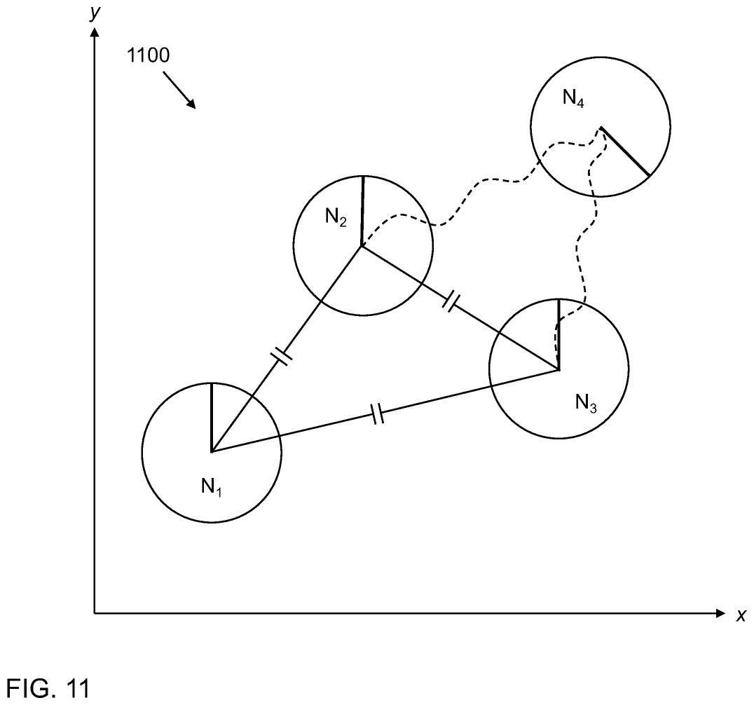

Referring to FIGS. 10 and 11, there are shown graphs 1000, 1100 in which the orientations of the first, second and third nodes, N₁, N₂ and N₃, have been aligned and in which the relative bearings between them have been determined. The distance between the first, second and third nodes, N₁, N₂ and N₃, is not yet known, as indicated by the straight lines with breaks between them. For clarity, the relative bearings are not shown on FIGS. 10 and 11.

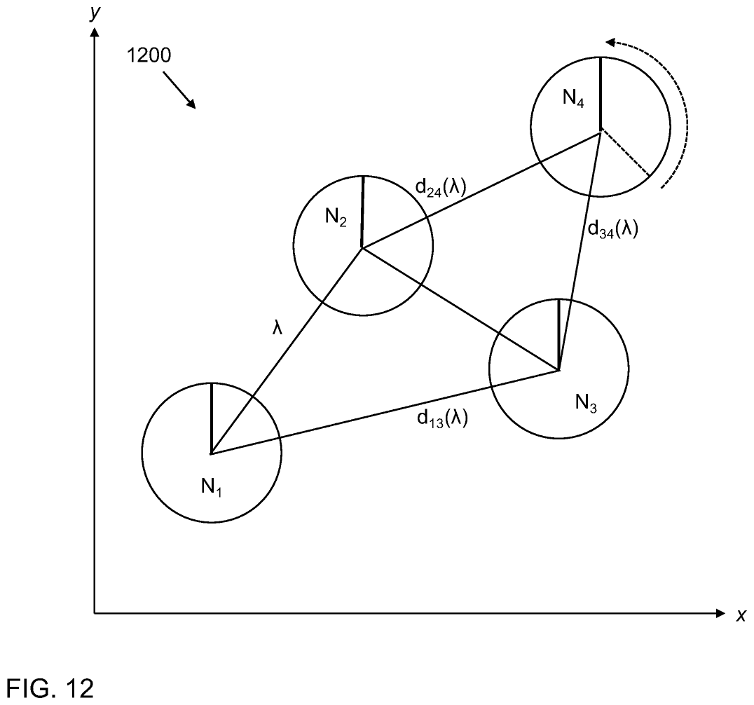

Referring to FIG. 12, there is shown a graph 1200 in which the first, second, third, and fourth nodes, N₁, N₂, N₃, and N₄, have been aligned and in which the relative bearings, β₁₂, β₁₃, β₂₃, β₂₄, and β₃₄, between them (not shown on FIG. 12, for clarity) have been fixed. The relative distances between the first, second, third, and fourth nodes, N₁, N₂, N₃, and N₄, have been determined, as indicated by solid, but thin lines between them. The graph 1200 represents orientations and bearings having been fixed, and relative distances being known. At this stage, an overall scale factor is unknown.

In order to obtain the graph 1200, node distances are recovered. With the bearings computed, it remains to be determined how far the individual nodes are apart. Two example techniques to determine the relative lengths of two edges connecting three nodes are provided. The relative distance computation component 235 may determine relative lengths. If the absolute length of one of the edges is already known, this ratio can be used to fix the other length. The length of a single edge in the graph is then fixed. Using either of the two techniques described below (or a combination), the graph is traversed from this starting point to determine all edge lengths. This first edge length in effect becomes a scaling factor, A, for the entire tour. The first edge length can be set in a variety of ways, as described below.

The edge length ratio may be determined based on the bearing graph. The bearing graph is the correspondence graph after bearings have been computed for it; the correspondence graph is defined as the first step of computing the bearing graph. If there are redundant edges in the bearing graph obtained previously, they can be used to compute relative edge lengths. Specifically, for each complete three-node subgraph in the bearing graph, the bearings can be used to determine the inner angles of the triangle connecting these nodes. The law of sines then determines the ratios between all three edges. If one of the edges already has a known length, lengths can be assigned to both of the other two edges. This technique does not work when the three nodes in question are colinear, as the resulting triangle would be degenerate. In such cases, the graph is traversed via different edges if possible, or the technique may fall back to the triplet correspondence technique described below. As such, when first, second and third nodes are non-collinear, a relative distance computation can be based on interior angles of a triangle of which the first, second and third nodes are vertices.

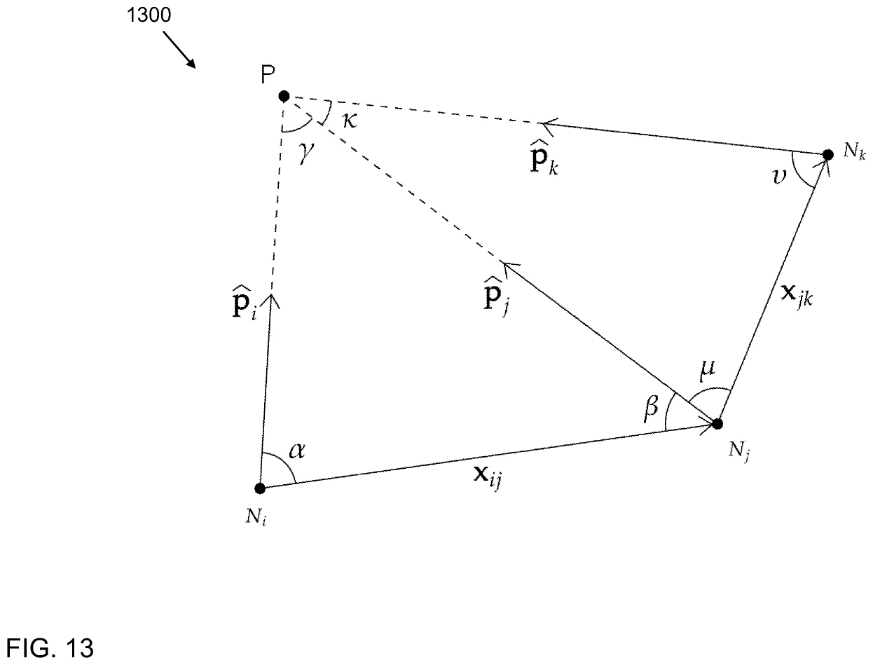

Referring to FIG. 13, there is shown a representation 1300 of a triplet correspondence technique. The representation 1300 depicts how relative distances can be determined based on triplet correspondences.

As indicated above, the edge length ratio may be determined based on triplet correspondences. Consider the length of the edge between nodes Nᵢ and Nⱼ, denoted xᵢⱼ. The ratio |xᵢⱼ|/|xⱼₖ| of the lengths of two edges connecting three nodes, Nᵢ, Nⱼ and Nₖ, can be computed by using a point of interest, P, in the environment which is visible from all three nodes. Such a point is referred to herein as a “triplet correspondence”, since it is visible from three nodes. The two edges, and the three lines connecting each node to the triplet correspondence, together form two triangles as shown in FIG. 13. The law of sines can be applied as follows, in order to calculate the length ratio between the two edges:

$$\frac{sin γ}{\vert {x}_{ij} \vert} = \frac{sin α}{\vert {p}_{j} \vert} and \frac{sin κ}{\vert {x}_{jk} \vert} = \frac{sin v}{\vert {p}_{j} \vert} ; \\ \vert {x}_{jk} \vert = \frac{sin α sin κ}{sin v sin γ} \vert {x}_{ij} \vert ; \\ α = {cos}^{- 1} ( {\hat{x}}_{ij} \cdot {\hat{p}}_{i} ) ; \\ β = {cos}^{- 1} ( - {\hat{x}}_{jk} \cdot {\hat{p}}_{k} ) ; \\ γ = π - α - β ; \\ μ = {cos}^{- 1} ( {\hat{x}}_{jk} \cdot {\hat{p}}_{j} ) ; \\ v = {cos}^{- 1} ( - {\hat{x}}_{jk} \cdot {\hat{p}}_{k} ) ; and \\ κ = π - μ - v .$$

Again, this method uses triangles that are not degenerate. As such, the triplet correspondence, P, is not colinear with either of the two edges. For additional robustness, any number of triplet correspondences can be provided, for example by the user. A ratio can be computed for each triplet correspondence, and the median result, or another form of average, used.

As such, in this example, the immersive experience comprises a third node, Nₖ, comprising a third scene. A relative distance computation is performed in relation to the first, second and third nodes, Nᵢ, Nⱼ and Nₖ. The relative distance computation includes computing a measure of difference between (i) a distance between the first and second nodes, |xᵢⱼ|, and (ii) a distance between the second and third nodes, |xⱼₖ|. In this example, the measure of difference is a ratio between |xᵢⱼ| and |xⱼₖ|. However, other measures of difference may be used.

In this example, the distance between the second and third nodes, |xⱼₖ|, has been determined based on the determined measure of difference and the determined distance between the first and second nodes, |xᵢⱼ|. The relative distance computation may include computing a measure of difference between (i) the distance between the first and second nodes, |xᵢⱼ|, and (ii) a distance between the first and third nodes, |xᵢₖ|. The distance between the first and third nodes, |xᵢₖ|, may be determined based on (i) the determined measure of difference between the distance between the first and second nodes and the distance between the first and third nodes and (ii) the determined distance between the first and second nodes, |xᵢⱼ|.

In the example described above with reference to FIG. 13, the relative distance computation may be based on angles between a given reference point, P, in each of the first, second and third scenes and capture viewpoints of the first, second and third nodes, Nᵢ, Nⱼ and Nₖ. This triplet correspondence technique may be used when the first, second and third nodes, Nᵢ, Nⱼ and Nₖ, are collinear, and may also be used when the first, second and third nodes, Nᵢ, Nⱼ and Nₖ, are non-collinear.

A traversal algorithm will now be described. The above two methods can be used to determine edge lengths for the entire tour. This is technically another breadth-first traversal (BFT), though a new graph, or rather hypergraph, is defined for it. The new graph is referred to herein as a “distance graph”. Each edge of the bearing graph, and each edge covered by a triplet correspondence, becomes a hypernode of the distance graph. Each triangle (complete three-node subgraph) in the bearing graph, and each triplet correspondence, becomes a hyperedge connecting the hypernodes covered by that triangle or correspondence. Similar to the bearing graph, the distance graph should be connected.

The BFT over a hypergraph works, in effect, in the same way as a BFT over a regular graph. The length of an arbitrary edge or hypernode is fixed, as described below. A queue of unprocessed hyperedges is maintained, which is initialised with all hyperedges connected to the initial hypernode. Then, repeatedly, the first hyperedge is dequeued, the appropriate edge length ratio determination technique is applied to fix the lengths of the other two hypernodes connected to it, and all hyperedges connected to those are put into the queue. This process is repeated until the queue is empty and all hypernodes have been processed. Lastly, the lengths from the distance graph and the angles from the bearing graph are combined to compute an absolute position for each node in the tour using trigonometry.

This leaves the problem of determining the first edge's length or, equivalently, finding a scaling factor for the overall tour. A number of techniques to solve this problem and fix the scaling factor are provided. Scaling factor estimation may be performed by the scaling factor estimation component 240.

The most accurate option is for the tour author to measure the distance between two viewpoints while shooting the tour. This gives an exact distance for reference. However, this also involves additional effort during tour acquisition. The distance between the first and second nodes, N₁ and N₂, may therefore be determined based on user input indicating the distance between the first and second nodes, N₁ and N₂.

Alternatively, the camera height may be used. This can be easier to obtain for several reasons. Since tours are normally shot with a tripod, that tripod may be set to a standard height that can be determined at any point before or after shooting the tour. This can also be used consistently across many tours.

If that is not the case, it is also possible to determine the camera height in post-production. Any object on a scene's equator is at the same height as the camera. This gives a lot of potential reference points. Machine learning techniques may also determine the camera height automatically. Once the camera height has been determined for one node, a correspondence at floor level and trigonometry equivalent to that presented above can be used to work out the length of any adjacent edge. Examples of such correspondence include, but are not limited to, the bottom corner of a room and the bottom of a leg of a chair.

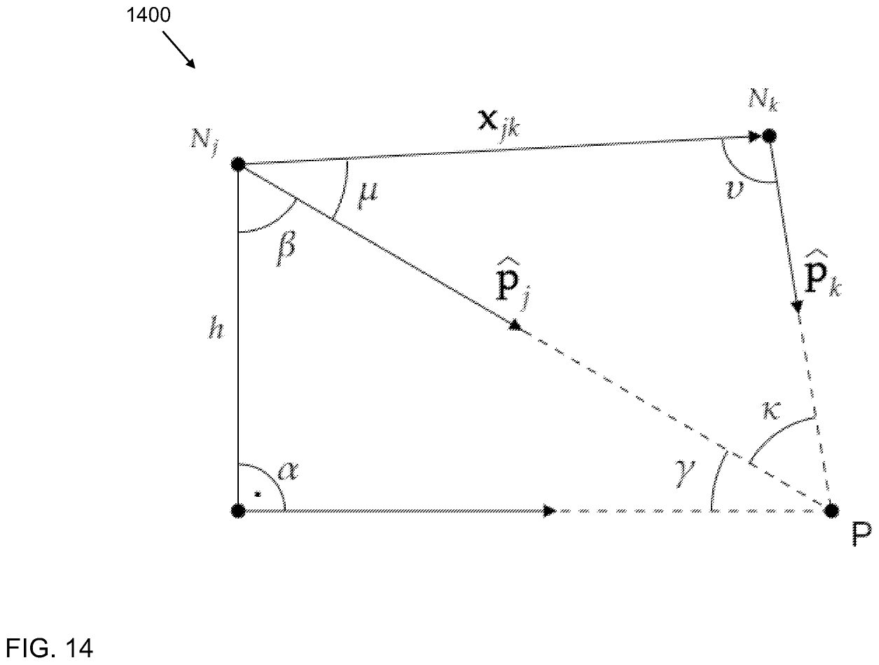

Referring to FIG. 14, there is shown a representation 1400 of how camera height, h, can be used to determine an adjacent edge length in post-production.

The edge length may be determined from the camera height, h. In particular, the distance between two nodes may be determined based on the camera height of one of the nodes. The corresponding geometry is the same as that described above with reference to FIG. 13, except with xᵢⱼ being replaced with h, and α being 90°, assuming the point P is at floor level.

As such, the distance between the first and second nodes, N₁ and N₂, may be determined based on estimating a height, h, of a capture device, such as the camera 105, used to capture the first, second and/or third scene. Such determination may use a reference point at floor level. Such a reference point may be a correspondence used in one or more other techniques described herein.

Lastly, machine learning methods may be used to determine the scaling factor. For instance, a model may be trained to recover a depth field corresponding to a 360° scene. Doing so for two different scenes allows a distance from either scene to a shared correspondence to be assigned. This can be used to determine the distance between the nodes using trigonometry. As such, the distance between the first and second nodes, N₁ and N₂, may be determined based on machine learning and/or computer vision.

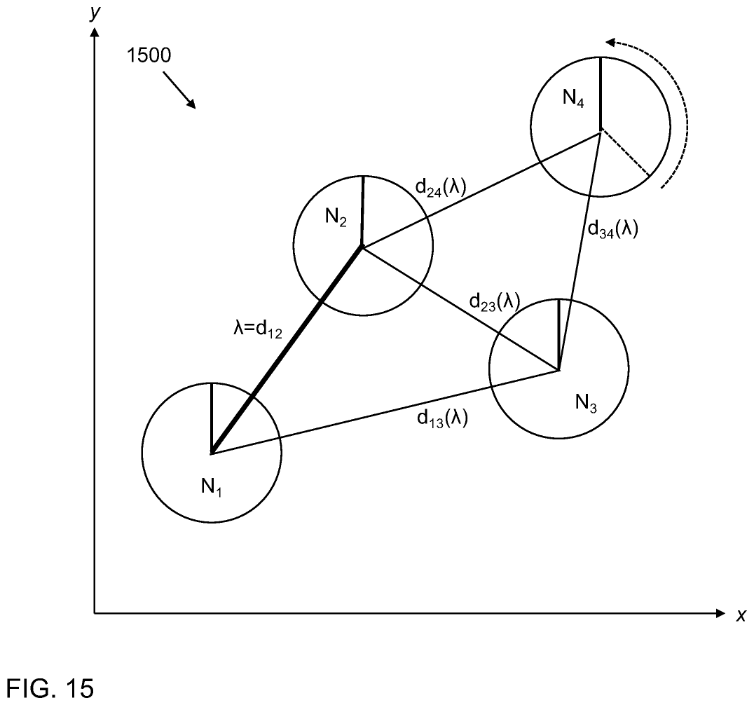

Referring to FIG. 15, there is shown a graph 1500 corresponding to the graph 1400 where the length of the first edge between the first and second nodes, N₁ and N₂, has been set. As such, in this example, the distance between the first and second nodes, N₁ and N₂, has been determined.

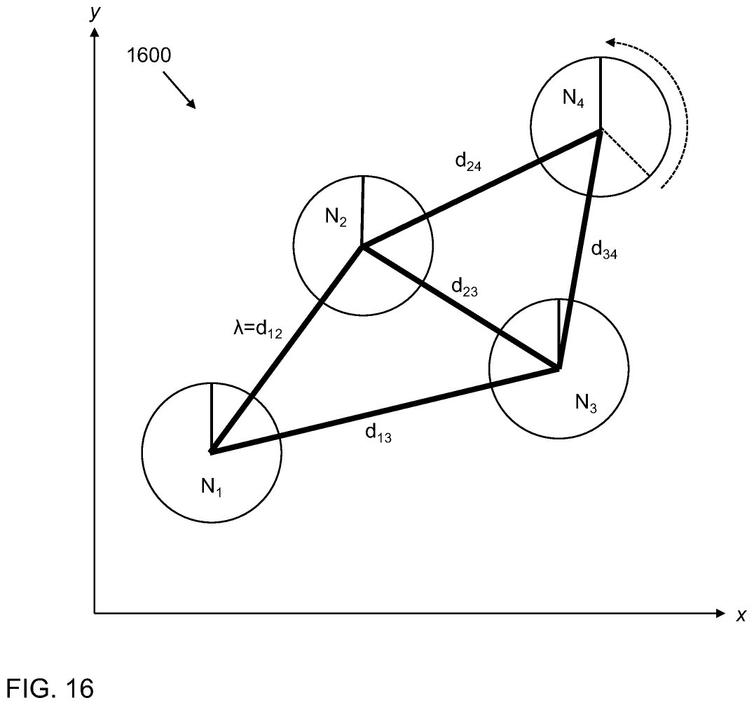

Referring to FIG. 16, there is shown a graph 1600 corresponding to the graph 1500 where the length of all edges has been set. The graph 1600 represents a final tour configuration. All orientations, bearings and absolute distances are known. The absolute positioning component 245 may generate the final tour configuration.

In some examples, geotagging is used. Geotagging data may be used by the geotagging component 215. In more detail, geotagging data in the 360° scene files may be used to position and rotate the nodes of the tour. However, accuracy of geotagging data is relatively poor and can vary greatly, especially indoors or in big cities. Geotagged data can nevertheless be used in conjunction with the present disclosure to provide an approximate initial configuration of the tour. The initial configuration can then be refined with the techniques described herein. In any case, the present disclosure can configure tours where geotagging data is not available at all. As such, the first and/or second node may comprise geotagging data relating to capture of the first and/or second scene. The geotagging data may be used in the configuring of the immersive experience.

By way of a summary, various techniques have been described above for aligning and positioning the nodes of a tour in a fully or partially automated way. As input, an unstructured set of 360° scenes is provided. This is augmented with a graph of correspondence data between pairs of nodes. The radial lines depicted in the associated Figures represent a consistent, but as yet unknown, reference direction, such as true north. A rotation is determined and performed for each scene, so that the scenes are aligned consistently. The direction of travel and/or bearing between pairs of nodes is determined. Ratios, or other measures of difference, between the lengths of pairs of edges are determined. An overall scaling factor for edge lengths is determined. Together with the edge length ratios and bearings, absolute positions and orientations for all nodes in the tour are computed.

The reader is referred to WO-A1-2020/084312, filed by the present applicant, which relates to providing at least a portion of content having 6DOF motion and the entire contents of which are hereby incorporated herein by reference. As explained above, 6DOF motion allows the user to move about to explore a space freely. The reader is also referred to a UK patent application filed by the present applicant on the same date as the present application, entitled “Rendering An Immersive Experience” and relating to natural transitions between scenes, the entire contents of which are also hereby incorporated herein by reference. With a system providing 6DOF motion and natural transitions between scenes, accurate positioning and rotation of each scene significantly enhances the immersive experience. As such, the present disclosure has a strong synergy with, and enhances, the natural locomotion throughout a virtual tour enabled by providing 6DOF motion and natural transitions between scenes.

As explained above, existing virtual tours can typically only be viewed from a number of fixed camera positions. This makes them inadequate for VR experiences and limits their realism and flexibility for browser-based experiences. The present disclosure provides a tour system that allows the user to move anywhere within the tour space and explore the environment freely. Applying the techniques described herein enable the process of building a tour from individual 360° scenes to be fully or partially automated, depending on the requirements of any given tour and tour author.

Compared to existing systems, examples described herein enable a user to view scenes from viewpoints other than the camera viewpoints, including when viewed in VR. Examples described herein position tour nodes automatically, rather than manually. Examples described herein enable the geometry and the placement and orientation of nodes to reflect the physical space accurately. Examples described herein support 360° video content.

Various measures have been described above in relation to configuring an immersive experience. Such measures include methods, apparatuses configured to perform such methods and computer programs comprising instructions which, when the program is executed by a computer, cause the computer to perform such methods.

In the context of this specification “comprising” is to be interpreted as “including”.

Aspects of the invention comprising certain elements are also intended to extend to alternative embodiments “consisting” or “consisting essentially” of the relevant elements.

Where technically appropriate, embodiments of the invention may be combined.

Embodiments are described herein as comprising certain features/elements. The disclosure also extends to separate embodiments consisting or consisting essentially of said features/elements.

Technical references such as patents and applications are incorporated herein by reference.

Any embodiments specifically and explicitly recited herein may form the basis of a disclaimer either alone or in combination with one or more further embodiments.

1. A method of configuring an immersive experience, the immersive experience comprising first and second scenes, the method comprising:
identifying first and second reference points in the first scene;
identifying the first and second reference points in the second scene; and
determining a relative bearing between the first and second scenes using the identified first and second reference points in the first and second scenes.

2. The method according to claim 1, wherein determining the bearing comprises:
determining a first direction of travel between the first and second scenes using a difference between positions of the first reference point in the first and second scenes and a difference between positions of the second reference point in the first and second scenes; and
deriving the bearing using the first determined direction of travel.

3. The method according to claim 2, wherein the first and second scenes each comprise a third reference point, and wherein determining the bearing comprises:
determining at least one further direction of travel between the first and second scenes using:
the difference between positions of the first reference point in the first and second scenes and a difference between positions of the third reference point in the first and second scenes; and/or
the difference between positions of the second reference point in the first and second scenes and the difference between positions of the third reference point in the first and second scenes; and
deriving the bearing using the at least one further determined direction of travel.

4. The method according to claim 3, wherein the at least one further direction of travel comprises:
a first further direction of travel between the first and second scenes determined using the difference between positions of the first reference point in the first and second scenes and the difference between positions of the third reference point in the first and second scenes; and
a second further direction of travel between the first and second scenes determined using the difference between positions of the second reference point in the first and second scenes and the difference between positions of the third reference point in the first and second scenes.

5. The method according to claim 3, wherein the first determined direction of travel is different from the at least one further determined direction of travel, wherein a difference between the first determined direction of travel and the at least one further determined direction of travel is dependent on an orientation of the first and/or second scene, wherein the method comprises performing azimuthal alignment of the first and second scenes, and wherein the azimuthal alignment comprises:
orienting the first and/or second scene to minimise the difference between the first determined direction of travel and the at least one further determined direction of travel.

6. The method according to claim 1, wherein the immersive experience comprises a third node comprising a third scene, wherein the method comprises performing a relative distance computation in relation to the first, second and third nodes, and wherein the relative distance computation comprises computing a measure of difference between:
a distance between the first and second nodes; and
a distance between the second and third nodes.

7. The method according to claim 6, wherein the first, second and third nodes are non-collinear, and wherein the relative distance computation is based on interior angles of a triangle of which the first, second and third nodes are vertices.

8. The method according to claim 6, wherein the relative distance computation is based on angles between a given reference point in each of the first, second and third scenes and capture viewpoints of the first, second and third nodes.

9. A method according to claim 6, comprising determining the distance between the first and second nodes, optionally wherein the distance between the first and second nodes is determined based on user input indicating the distance between the first and second nodes.

10. (canceled)

11. The method according to claim 9, wherein the distance between the first and second nodes is determined based on estimating a height of a capture device used to capture the first, second and/or third scene;
optionally wherein the first and second reference point is at floor level.

12. (canceled)

13. The method according to claim 9, wherein the distance between the first and second nodes is determined based on machine learning and/or computer vision.

14. The method according to claim 9, comprising:
determining the distance between the second and third nodes based on the determined measure of difference and the determined distance between the first and second nodes.

15. The method according to claim 9, wherein the relative distance computation comprises computing a measure of difference between:
the distance between the first and second nodes; and
a distance between the first and third nodes;
optionally further comprising:
determining the distance between the first and third nodes based on:
the determined measure of difference between the distance between the first and second nodes the distance between the first and third nodes; and
the determined distance between the first and second nodes.

16. (canceled)

17. The method according to claim 1, wherein the first and second reference points are identified in the first and second scenes based on user input indicating the first and second reference points; and/or
wherein the first and second reference points are identified in the first and second scenes based on machine learning and/or computer vision.

18. (canceled)

19. The method according to claim 1, wherein the first and/or second node comprises geotagging data relating to capture of the first and/or second scene, and wherein the method comprises using the geotagging data in the configuring of the immersive experience.

20. The method according to claim 1, comprising performing equatorial alignment of the first and/or second scenes such that equators of the first and/or second scenes are both horizontal.
optionally wherein equatorial alignment comprises, for the first and/or second scene:
identifying parallel lines in the scene; and
rotating the scene such that a direction of the identified parallel lines corresponds to a direction of the corresponding reference parallel lines in physical space.

21. (canceled)

22. The method according to claim 20, wherein the equatorial alignment comprises using machine learning and/or computer vision.

23. The method according to claim 1, wherein the first and/or second scene comprises panoramic image data and/or panoramic video data.

24. Apparatus configured to perform a method of configuring an immersive experience, the immersive experience comprising first and second scenes, the method comprising:
identifying first and second reference points in the first scene;
identifying the first and second reference points in the second scene; and
determining a relative bearing between the first and second scenes using the identified first and second reference points in the first and second scenes.

25. A computer program comprising instructions which, when the program is executed by a computer, cause the computer to perform a method of configuring an immersive experience, the immersive experience comprising first and second scenes, the method comprising:
identifying first and second reference points in the first scene;
identifying the first and second reference points in the second scene; and
determining a relative bearing between the first and second scenes using the identified first and second reference points in the first and second scenes.
